(19) United States
(12) Patent Application Publication
(10) Pub. No.: US 2012/0329532 A1
(43) Pub. Date: Dec. 27, 2012

(54) BATTERY CHARGE APPARATUS FOR MOBILEPHONE

(75) Inventor: Yoon-Hwoa KO, Bucheon (KR)

(73) Assignee: HDPRO CO.,LTD, Bucheon (KR)

(21) Appl. No.: 13/354,665

(22) Filed: Jan. 20, 2012

(30) Foreign Application Priority Data
Jun. 27, 2011 (KR) 10-2011-0062401

(51) Int. Cl. H04W 52/00

(52) U.S. Cl. 455/573

(57) ABSTRACT

The present invention discloses a battery charge apparatus for a mobile phone, wherein the current output contact portions and the current input contact portions get in contact with each other in a comfortable and safe manner by magnetic force when charging.

### CROSS-REFERENCE TO RELATED APPLICATION

This application claims priority to and the benefit of Korean Patent Application No. KR 10-2011-0062401 filed in the Korean Intellectual Property Office on Jun. 27, 2011, the entire contents of which are incorporated herein by reference.

### BACKGROUND OF THE INVENTION

(a) Field of the Invention

The present invention relates to a battery charge apparatus of a mobile phone, more particularly, the invention relates to a mobile phone battery charger enabling to charge battery power more safely by means of making power supplying input and output contacts that are mounted to protective cover and charger of a mobile phone to be rigidly maintained in a mutually contacted state due to magnetic force of a magnet.

(b) Description of the Related Art

In general, a portable wireless communication terminal (referred to as a “mobile phone”) indicates a hand-held device that can receive and send a wide variety of services, in addition to telephony, such as video information, over a radio link amongst a handset, a base station, a cellular network provided by a mobile phone operator and the public telephone network.

Such a mobile phone combines a battery, notably replaceable and rechargeable, through which various electronic parts mounted within the mobile phone can be electrically powered and used battery power can be structurally recharged.

The abovementioned battery basically consists of a pair of negative terminal (cathode) and positive terminal (anode) in either lower part of the back, sloped part or border part, being charged when electrically connected with an external power source.

There are two types of battery charging, being conducted on a daily basis or one time for a few days; one is the corded charging type that is charged when a phone is directly connected with positive and negative terminals of a separate battery charger or by connecting a connection jack that is in one side of a phone with a connector of external charger in a state that a battery is mounted on a mobile phone, whereas the other is the cordless charge type alleviating the need for external connections, in which a battery mounted on a phone starts to be charged by means of wireless frequency charging function when a phone's charging case is placed on a wireless charging pad.

Each of the types as above has its unique features; typically, as for the cordless type, the charging pad system is expensive and lower charging efficiency, while as for the corded type when compared with the former it has an advantage of cost saving but invokes problematic inconvenience for use in an attempt to charge a phone in a manner of connecting a terminal or a charger connector or a gender that suits the phone where applicable and then in turn connecting the gender with a connection jack of the phone due to likeliness that the connection is not fixedly made and/or that a plate spring acting as a hook for fixation is damaged.

In this regard, this invention is proposed on a battery charge apparatus that takes advantage of magnetic field induction, making easier the electric power connection in the aforesaid corded charging type and at the same time making terminals in contact with each other more fixedly.

Prior arts available up to now with respect to a battery charging apparatus taking advantage of a magnet include: locally registered patent no. 10-0402916, titled “Multi-type Mobile Phone Charger & Control Method Thereof”; locally registered patent no. 10-0736399, titled “Non-Inserted Contact-Type Interface Using Magnet”; locally registered utility model no. 20-0304121, titled “Multi-type Battery Charge Apparatus of Mobile Phone”; locally registered utility model no. 20-0351676, titled “Connector Connecting Apparatus for Mobile Phone” and locally registered utility model no. 20-0379697, titled “Connector for Mobile Phone Charger”.

As per the foregoing, the locally registered patent no. 10-0402916, titled “Multi-type Mobile Phone Charger & Control Method Thereof”, relates to an invention that a battery terminal and a contact terminal of charger are mutually closely contacted due to gravitational force acting between opposite electrodes by mounting a pair of magnets having different polarity to each of mobile phone's battery and charger's housing.

In addition, the locally registered patent no. 10-0736399, titled “Non-Inserted Contact-Type Interface Using Magnet” as above, relates to an invention that comprises of the connection portion in which contact terminals are formed for power and data link through facial contact with contact terminals that are formed in the interface portion of an external device; and the protruded magnet portion where the magnet protruded gets contacted with the metallic strip configured in an insertion groove of the interface portion in an external device, so that contact terminals come to be more strongly adhered with the help of the protruded magnet when it contacts with the metallic strip.

In addition, the locally registered utility model no. 20-0304121, titled “Multi-type Battery Charge Apparatus of Mobile Phone” as above, relates to an invention that loose contacting between battery and charger due to shock nearby during charging is prevented by means of permanent magnets being magnetically bonded with a magnetic material that exists within the inside of that battery, being designed to compromise: the power supply portion that supplies power to the inside of a mobile phone through cord; the charging portion composed of contact terminals that are powered by the abovementioned power supply portion and variable rails that enable the aforesaid contact terminals to move; permanent magnet(s) positioned to the upward/downward directions of the charging portion within the aforesaid charging apparatus of a mobile phone; and charging display that shows the status of charging as per the aforesaid battery of mobile phone.

In addition, the locally registered utility model no. 20-0351676, titled “Connector Connecting Apparatus for Mobile Phone” as above, pertains to an invention that gravitational force of magnets is utilized in preventing separation of connector that slips in the interface portion, while making it more closely contacted, being equipped with a means of attaching/detaching magnets that are located in the perimeter of the interface in the rear edge part of a mobile phone and in the perimeter of the connection terminal in the frontal edge part of connector.

In addition, the locally registered utility model no. 20-0379697, titled “Connector for Mobile Phone Charger” as above, pertains to an invention with a configuration that comprises: the contact terminal whose frontal portion is projected forward so that it can be inserted into a connection jack of external device for charging of a mobile phone with a function that a variety of data including power is received and sent through it; magnets mounted on the rear side of the aforesaid contact terminal; and one or more metallic parts that are configured around the aforesaid contact terminal in a protruded form but their rear sides are attached with the aforesaid magnets—being contacted with the metallic portion of the connection jack when connected with the aforesaid contact terminal due to magnetic force of magnets—so as to strongly maintain contacting between the connection terminal and the contact terminal when the aforesaid metallic parts magnetized due to the aforesaid magnets are attached with the metallic portion due to magnetic force.

Conventional battery charging apparatuses as mentioned above mostly depend on the use of magnets and/or the metallic portion as a means to make contact terminals to be closely contacted for charging by way of transferring direct current that is generated by a charger to a battery that is either mounted on or separated from a mobile phone, where such magnets and/or the metallic portion is arranged in a state of being independently spaced apart from the contact terminals, which intrinsically gives rise to damage to the electric circuit portion and battery due to short circuit arising from contacting with other contact terminal in the opposite side when such magnets and/or the metallic portion are mutually contacted for charging.

In this juncture, a necessity for the combination structure not only leading to easy-to-attach/detach comfort taking advantage of magnets, but for accomplishing safe contacting of contact terminals is demanded.

### SUMMARY OF THE INVENTION

Accordingly, the current invention aims to offer solution against conventional problems as mentioned above; more specifically, its objective lies in providing a battery charge apparatus of mobile phone capable of maintaining charging through rigid contacting of output terminals—separated into anode and cathode—of the charger and input terminals in a protective cover of the mobile phone which are designed to have N pole and S pole, respectively, in a way that without fail those get contacted via gravitational (attractive) force when polarity of magnetic forces differs with each other, and get separated via repulsive force when polarity of magnetic forces is identical with each other.

Another objective of this invention is to provide a battery charge apparatus of mobile phone having a safety feature by devising the output terminal of a charger that supplies current to be structured so that it can be protruded when in use and retrieved when not in use, while making the output terminal that has been contacted with the input terminal to be automatically separated if charging is completely made with an aim to prevent overcharging and overheating of a battery.

To achieve the objectives as mentioned above, the battery charge apparatus for a mobile phone proposed by this invention comprises a mobile phone having a connection jack for current and data link, a charger being configured so as to induce positive electricity and negative electricity from a direct current power source to the output contact portions being connected to the PCB, an enclosure cover equipped with the PCB-connected input contact portions in such a manner that negative electricity and positive electricity can be supplied by contacting the output contact portions of the charger while being connected to a connector for data link and charging, In this regard, the output contact portions include anode and cathode output terminals which form a couple being exposed through two holes perforated on the top end of a housing thereof, fixation bolts engaged in such a manner that the output terminals are connected to the PCB on the lower part thereof, and the permanent magnets being arranged between the output terminals and the PCB generating magnetic force. Similarly, the input contact portions include anode and cathode output terminals which form a couple being exposed through two holes perforated on the bottom of a base thereof, fixation bolts engaged in such a manner that the input terminals are connected to the PCB on the lower part thereof, and the permanent magnets being arranged in between the input terminals and the PCB generating magnetic force. As for the permanent magnets thereof, the technological feature in terms of their configuration is that the surface polarity of the magnets differs with each other by arranging the cathode output terminal in the output contact portion to be polarized with S pole and the anode output terminal in the output contact portion to be polarized with N pole, while the aforesaid permanent magnets are conversely configured so that the cathode output terminal in the output contact portion to be polarized with N pole and the anode input terminal in the output contact portion to be polarized with S pole.

Furthermore, this invention has such technical features of making it possible for output terminals of the output contact portion to be projected and retrieved, adopting electromagnets no behalf of permanent magnets that fix the output terminals for disconnecting the connection of the output terminals once charging is made, and inserting metallic strips so as to prevent external exposure and movement of the output terminals.

The invention is featured by implementing different polarities of N pole and S pole as per cathode/anode output terminals in a charger and cathode/anode input terminals in a protective cover of a mobile phone so that without exception they get contacted when the polarity of current is different with each other, and they get separated when the polarity of current is same with each other, accordingly enabling to maintain the connection of the identical cathode/anode terminals with safety and conformity in every trial of charging through manual connection.

This invention relates to a novel construction of battery charge apparatus, leading to highly advantageous safety, by making the power-supplying output terminals of a charger to become sticked out when connected for charging and sticked back inwards during non-charging, where in the case of using electromagnets the output terminals having been connected with the input terminals are separated to prevent overcharging and overheating, in addition to prevention of movement of the output contact portion by employing metallic strips.

### BRIEF DESCRIPTION OF THE DRAWINGS

FIG. 1 is an exploded oblique view of a battery charge apparatus of a mobile phone according to the present invention.

FIG. 2 and FIG. 3 are exploded oblique views showing a protective cover of a battery charge apparatus of a mobile phone according to the present invention.

FIG. 4 is a partially enlarged sectional view showing a charger in a battery charge apparatus of a mobile phone and the status of contact in the output contact portions and the input contact portions of a protective cover according to the present invention.

FIGS. 5a and 5b are partially enlarged sectional view showing a charger in a battery charge apparatus of a mobile phone and the status of contact in the output contact portions and the input contact portions of a protective cover in a different embodiment according to the present invention.

FIGS. 6a and 6b are partially enlarged sectional view showing a charger in a battery charge apparatus of a mobile phone and the status of contact in the output contact portions and the input contact portions of a protective cover in an additionally different embodiment according to the present invention.

FIG. 7 is a partially enlarged sectional view showing the status of metallic strips being embedded into the support frames in the output contact portions for an embodiment as shown in FIG. 6a.

FIG. 8 is an oblique view showing the status of the input contact portions being fitted to a mobile phone itself.

FIG. 9 is an oblique view showing the status of the input contact portions being fitted to a battery built in a mobile phone.

### DETAILED DESCRIPTION OF THE EMBODIMENTS

The present invention will now be described in a detailed manner in connection with preferred embodiments according to the present invention by referring to the drawings attached herewith.

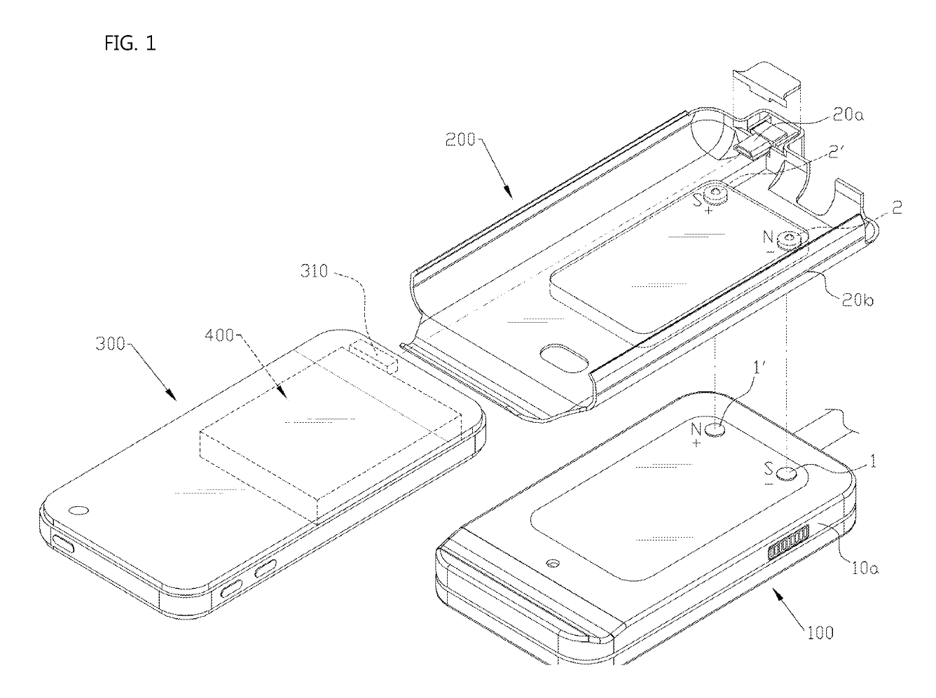

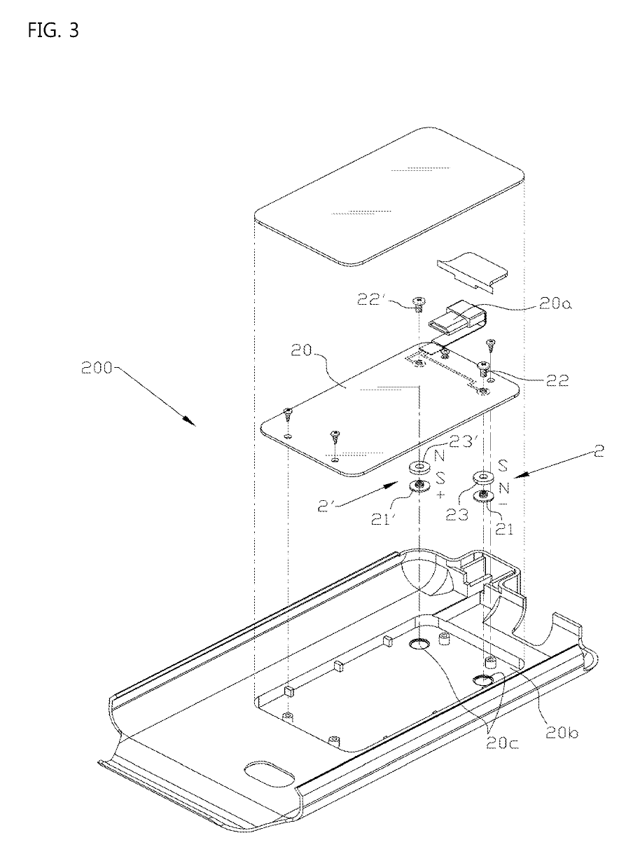

FIG. 1 and FIG. 3 are exploded oblique views showing a battery charge apparatus according to the present invention, where No. 100 indicates a charger, No. 200 a protective cover, No. 300 a mobile phone, Nos. 1 and 1′ the output contact portion, and Nos. 2 and 2′ the input contact portion, respectively.

The battery charge apparatus of a mobile phone with respect to this invention comprises a mobile phone (300) having a connection jack (310) for current and data link, a charger (100) configured to induce positive electricity and negative electricity from a direct current power source to the output contact portions (1, 1′) that are connected to a PCB (10), and a protective cover (200) equipped with a PCB (20) connected the input contact portions (2, 2′) in such a manner that negative electricity and positive electricity are supplied by contacting the output contact portions (1, 1′) of the charger (100) while being connected to a charger connector (20a) for data link and charging. The protective cover (200) thereof plays a role of protecting and charging a mobile phone (300).

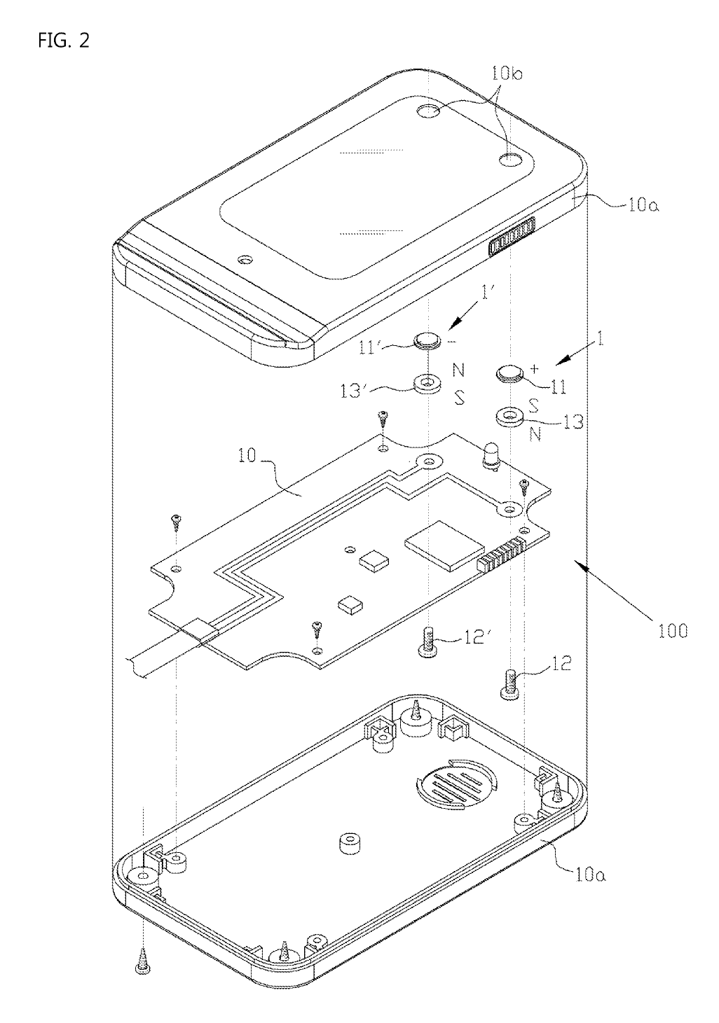

As shown in FIG. 2, the output contact portions (1, 1′) include anode and cathode output terminals (11, 11′) which form a couple being exposed through two holes (10b) perforated on the top end of a housing (10a) thereof, fixation bolts (12, 12′) engaged in such a manner that the output terminals (11, 11′) are connected to PCB (10) on the lower part thereof, and the permanent magnets (13, 13′) being arranged between the output terminals (11, 11′) and the PCB (10) generating magnetic force.

And, the permanent magnets (13, 13′) are arranged in such a manner that the surface polarity of the magnet differs with each other in a way that the cathode output terminal (11) and the anode output terminal (11′) in the output contact portions (1, 1′) are polarized with S pole and N pole, respectively.

As shown in FIG. 3, furthermore, the input contact portions (2, 2′) include anode and cathode output terminals (21, 21′) which form a couple being exposed through two holes (20c) perforated on the bottom of a base (20b) thereof, fixation bolts (22, 22′) engaged in such a manner that the input terminals (21, 21′) are connected to the PCB (20a) on the lower part thereof, and the permanent magnets (23, 23′) being arranged in between the input terminals (21, 21′) and the PCB (20) generating magnetic force.

And the permanent magnets (23, 23′) are arranged in such a manner that the surface polarity of the magnet differs with each other in a way that the cathode output terminal (21) and the anode output terminal (21′) in the input contact portions (2, 2′) are polarized with S pole and N pole, respectively.

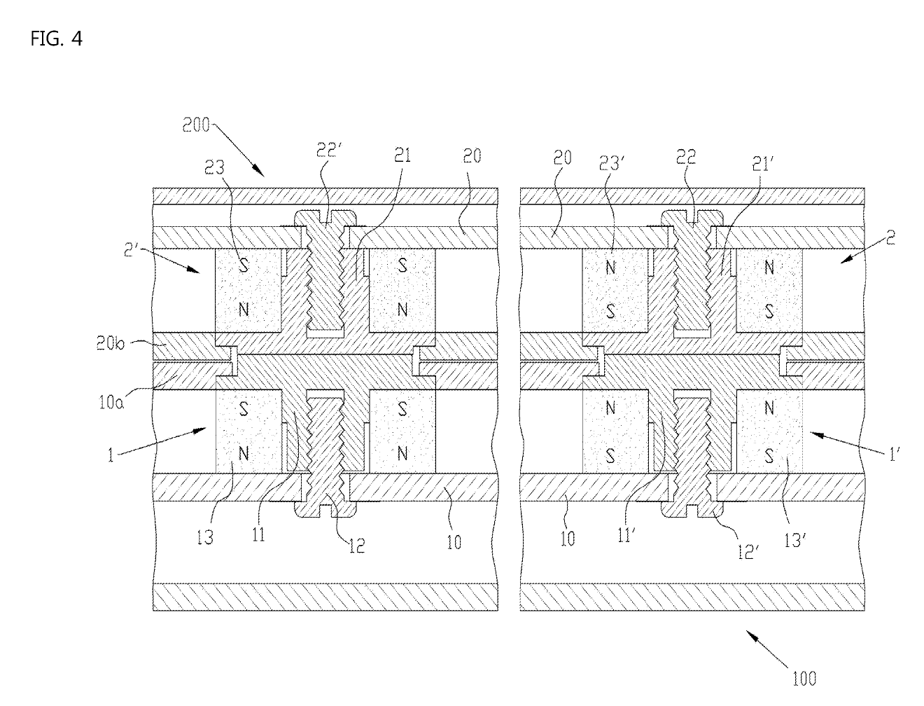

As such, this invention provides a safe contact of cathode and anode terminals all the time whenever a connection jack (310) of the mobile phone (300) after the protective cover (200) is slided into the mobile phone (300) as shown in FIG. 4, and is plugged to the connector (20a) of the protective cover (200), because like poles repel each other and that opposite poles attract each other in each time when the cathode input terminal (21) polarized with N pole and the anode input terminal (21′) polarized with S pole in the input contact portions (2, 2′) are to be contacted for charging with the cathode input terminal (21) polarized with S pole and the anode input terminal (21′) polarized with N pole in the output contact portion (1, 1′) of the charger (100).

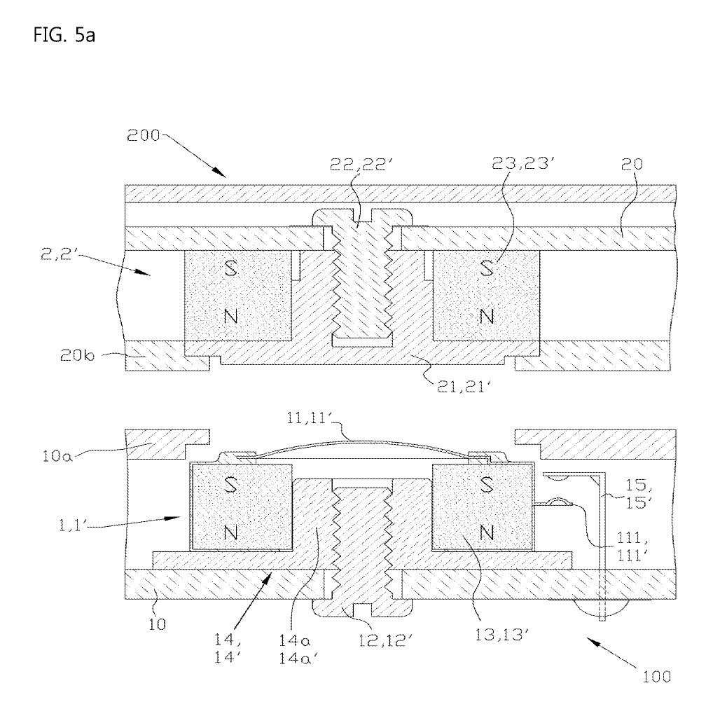

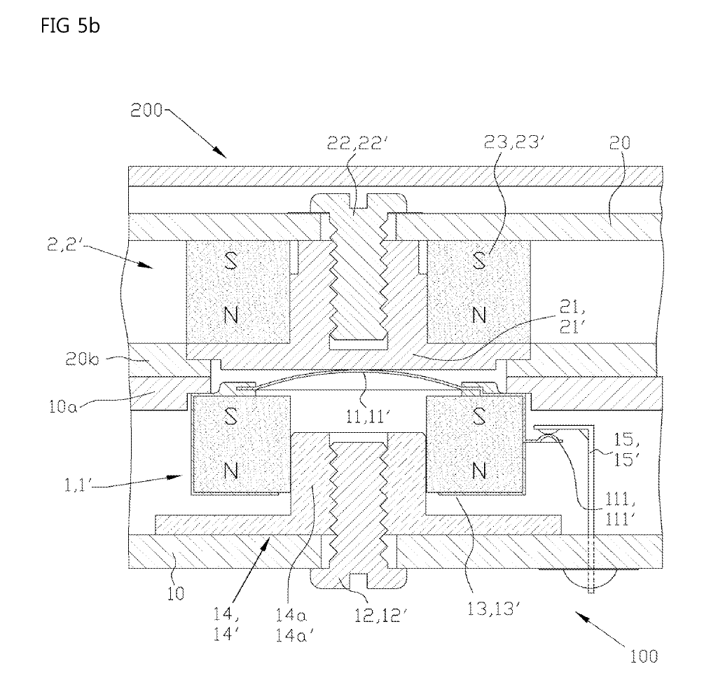

Another embodiment of this invention allows, as shown in FIG. 5a and FIG. 5b, the output contact portions (1, 1′) comprise the output terminals (11a, 11a′) formed on one side thereof in such a manner that the contact strips (111, 111′) are projected, the permanent magnets (13, 13′) where the edge part of the output terminals (11a, 11a′) thereof are injection molded into a resin layer and integrated in such a manner that the output terminals (11a, 11a′) are positioned to the top end, the support frames (14, 14′) having central rods (14a, 14a′) which are inserted through the central hollow portions of the permanent magnets (13, 13′), fixation bolts (12, 12′) fixing the support frames (14, 14′) to the PCB (10), and the fixed terminals (15, 15′) that are connected to the PCB (10) in such a manner that the contact strips (111, 111′) of the output terminals (11a, 11a′) are contacted or separated when the permanent magnets (13, 13′) move upward or downward.

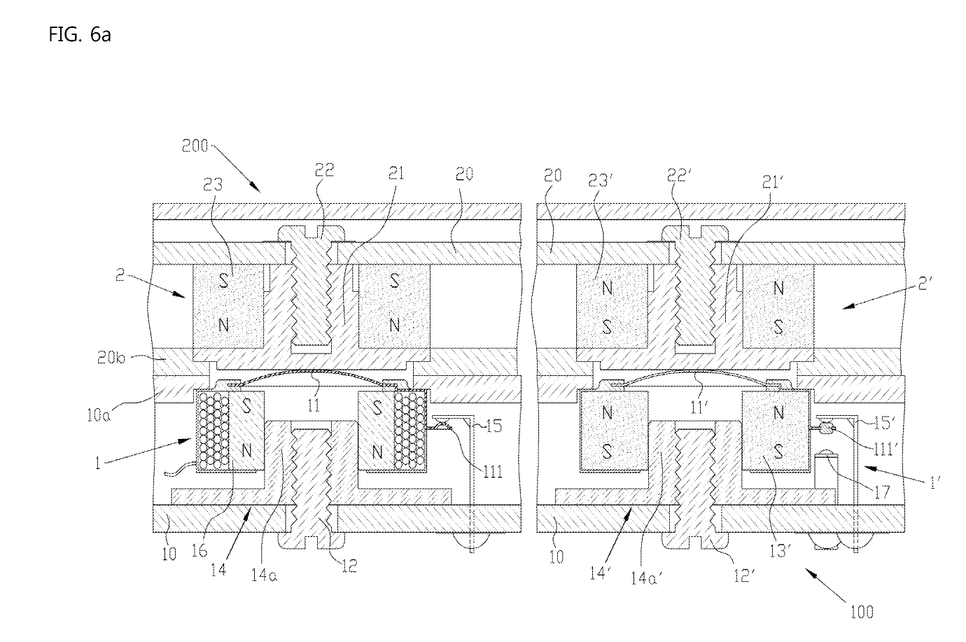

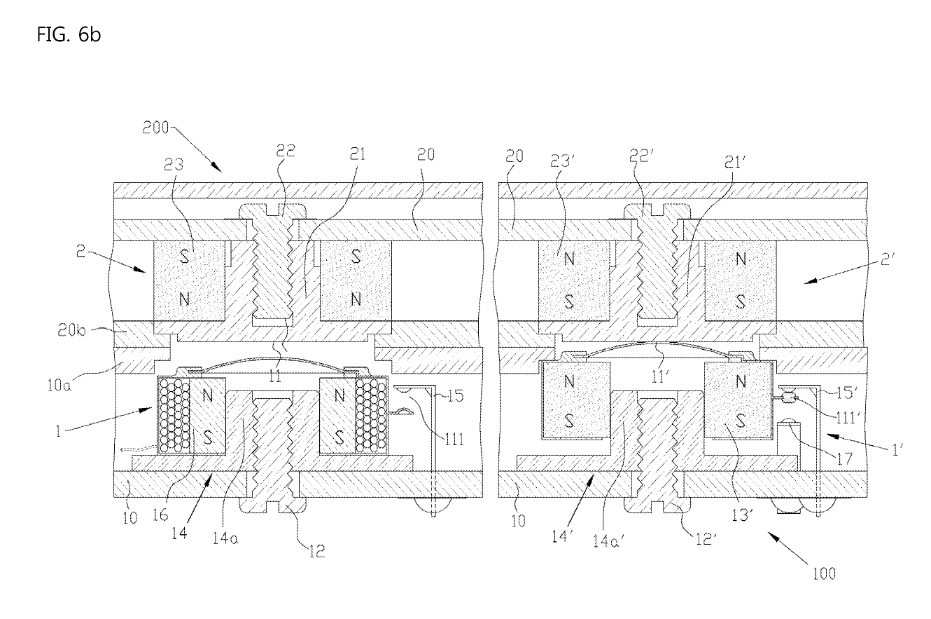

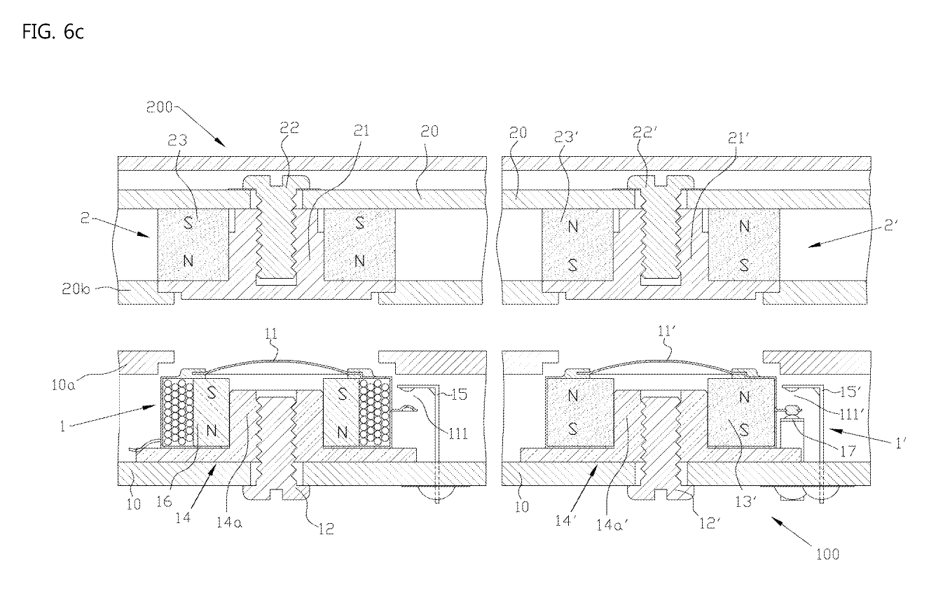

The following is provided as an additional embodiment of this invention by replacing, as shown in FIG. 6a and FIG. 6c, the permanent magnets (13) combining the output terminal (11a) in the output contact portion (1) that moves upward and downward with the electromagnet (16) and placing the second fixed terminal (17) being connected with PCB (10) so as to be contacted or separated to/from the contact strip (111) of the output terminal (11a); in other words, the second fixed terminal (17) is disconnected due to change in polarity of the electromagnet (16) when charging is complete and contacted again due to homing of polarity of the electromagnet (16) when recharging is started.

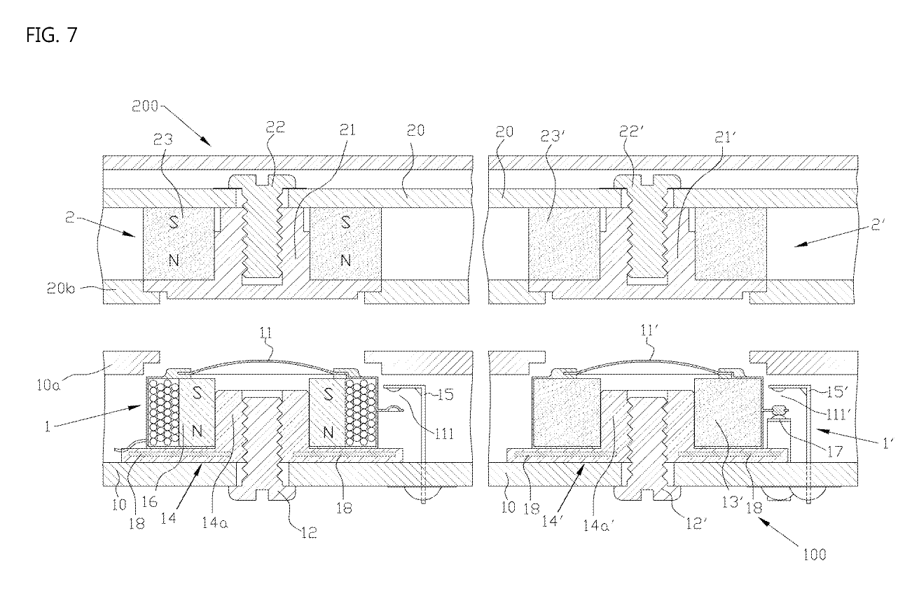

In addition, this invention incorporates a metallic strip (18) to be inserted into the lower part of support frames (14, 14′) so that permanent magnets (13, 13′) are attached, which fix output terminals (11a, 11a′) in a state that the output terminals (11a, 11a′) of the output contact portions (1, 1′) moving upward and downward is positioned lowered as shown in FIG. 7.

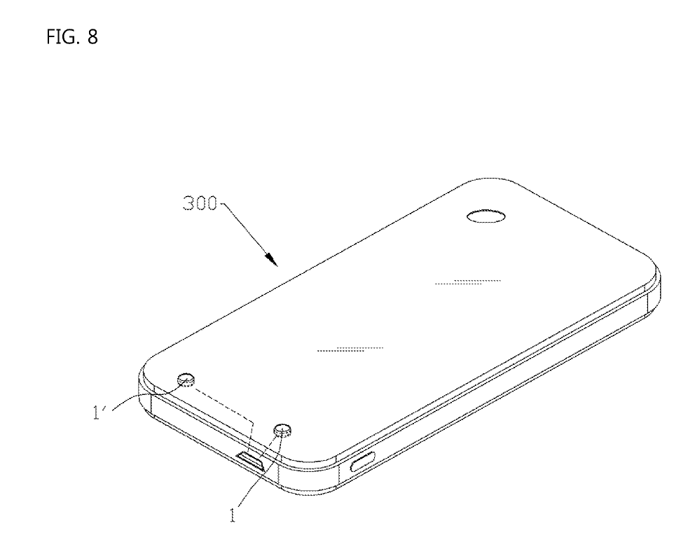

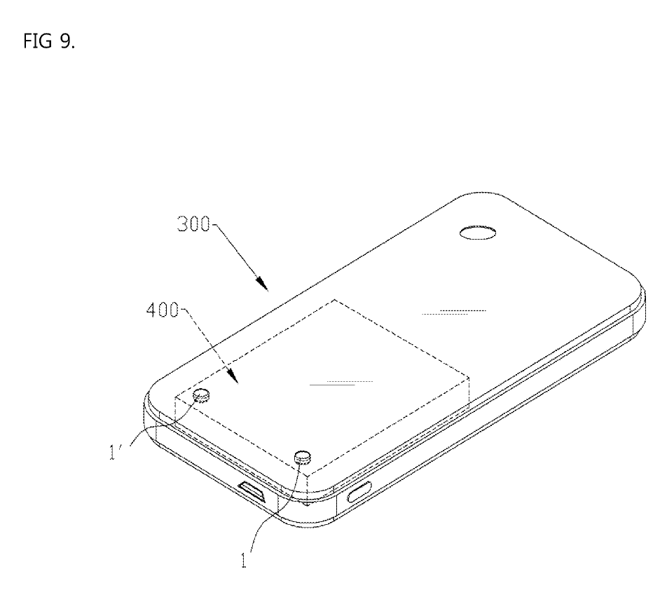

It should be noted that there is an alternative as per the configuration for charging in a way that the input contact portion (2, 2′) originally designed to be mounted on the protective cover (200) is directly mounted on the back cover (320) of a mobile phone (300) as shown in FIG. 8, or the battery (400) placed in the mobile phone (300) as shown in FIG. 9.

Next, following description regards to the operation of the battery charge apparatus of a mobile phone with respect to the present invention comprised as above.

To begin with, if the connection jack (310) of the mobile phone (300) is connected by plugging it to the connector (20a) of the protective cover (200) as shown in FIG. 1, they are in a state of being contacted with cathode (negative pole) and anode (positive pole) input terminals (2, 2′), which enables direct current to be supplied for charging while the protective cover (200) protects the mobile phone (300).

Next, the charger (100) produces negative (−) electricity and positive (+) electricity of direct current by converting alternating current being supplied through a cable not herein diagramed, where those negative (−) electricity and positive (+) electricity are transferred to the cathode (−) and anode (+) output contact portion (1, 1′).

Under the condition that readiness is made as above, to charge the battery (400) placed in the mobile phone (300), the input contact portions (2, 2′) of the protective cover (200) that is combined with the mobile phone (300) is contacted with the output contact portions (1, 1′) of the charger (100).

At this point, in the case where, as shown in FIG. 4, each of the N-pole magnetized cathode input terminal (21) and the S-pole magnetized anode input terminal (21′) in the input contact portions (2, 2′) are contacted with each of the S-pole magnetized cathode input terminal (11) and the N-pole magnetized anode input terminal (11′) in the input contact portions (1, 1′), the contacting thereof is smoothly made owing to action of attractive forces in a manner of matching with opposite poles.

In other words, both cathode/anode output terminals (11, 11′) belonging to the output contact portions (1, 1′) fixedly become contacted with both cathode/anode input terminals (21, 21′) belonging to the input contact portions (2, 2′) only when each of cathode (negative pole) and anode (positive pole) is consistent with each other, by making surface polarities of permanent magnets (13, 13′) applied to the output terminals (11, 11′) of the output contact portion (1, 1′) opposite to those of permanent magnets (13, 13′) applied to the input terminals (21, 21′) of the input contact portions (2, 2′). Reversely, provided that each of cathode and anode is inconsistent with each other, which means their magnetic polarities are identical with each other, no contacting amongst them is made in any case due to action of repelling force, accordingly providing greatest safety.

The abovementioned feature demonstrates novel comfort along with highest safety since, with no need of identifying one by one the contacting direction and position amongst the input contact portions (2, 2′) of the protective cover (200) and the output contact portions (1, 1′) of the charger (100), they shall be repelled (i.e. contacting not achievable) should there be identical polarities and attracted (i.e. contacting easily achieved) should there be opposite polarities.

Meanwhile, given that the input contact portions (2, 2′) of the aforesaid protective cover (200) and the output contact portions (1, 1′) of the charger (100) are kept in a fixed state, for the purpose of safety in use, the input contact portions (2, 2′) of the protective cover (200) that is always carried by a person is devised to be concealed to the inside of the base (20b) and the output contact portions (1, 1′) of the charger (100) to be in a state of protruding from the housing (10a) externally.

An additional application as an embodiment relating to this invention is to replace the type of the output contact portions (1, 1′) from the fixed type to the upward/downward moving type for safety in using the charger (100) being devised so that flow of current is interrupted during non-charging; more specifically, at the time of charging not made as shown in FIG. 5a, the contact strips (111, 111′) of the output terminals (11a, 11a′) are maintained in a state of being separated from the fixed terminals (15, 15′) that are connected to PCB (10) owing to their self-weight that makes them lowered; and when the input terminals (21, 21′) of the input contact portion (2, 2′) of the protective cover (200) approach for charging as shown in FIG. 5b, the output contact portions (1, 1′) is raised due to attractive forces created by magnetism of permanent magnets (23, 23′) in the input terminals (21, 21′) and permanent magnets (13, 13′) in the output terminals (11a, 11a′), and, at the same time with the rise of the output contact portions (1, 1′), both output terminals (11a, 11a′) and input terminals (21, 21′) are synchronously contacted and the contact strips (111, 111′) of the output terminals (11a, 11a′) get in touch with the fixed terminals (15, 15′), which allows current to flow smoothly for charging.

Reversely, if the protective cover (200) is detached through artificial human force, the output contact portions (1, 1′) disconnected is lowered owing to self weight, making the contact strips (111, 111′) of the output terminals (11a, 11a′) to be in a state of being separated from the fixed terminals (15, 15′) that are connected to PCB (10) with flow of current interrupted, which consequently renders safety.

An additional embodiment of this invention relates to the improved construction so that the output contact portions (1, 1′) is able to move upward and/or downward for safety in using the charger (100) by implementing an electromagnet (16) in replacement of the permanent magnet (13) in one output contact portion (1) and mounting the second fixed terminal (17) to the PCB (10) in the other output contact portion (1′) in order to alternate polarities of current that flows to the electromagnet (16), where the connecting direction of positive electricity and negative electricity changes through the electronic control portion not herein diagramed so that the surface polarity of the electromagnet (16) varies either to N pole or S pole.

More specifically in this regard, charging is made by inducing current in a way that, as shown in FIG. 6a, the output terminal (11) of the output contact portion (1) when acted by S pole comes to contact with the input terminal (21) of the input contact portion (2) having N pole through interaction of attractive force and, likewise in the opposite part, the output terminal (11′) of the output contact portion (1′) when acted by N pole comes to contact with the input terminal (21) of the input contact portion (2) having S pole through interaction of attractive force.

If charging is completely made through a series of processes as above, as shown in FIG. 6a, N-pole magnetism is activated to the output terminal (11) of the output contact portion (1) when the polarity of current having been flowing to the electromagnet (16) is oppositely changed through signals by the electronic control portion not herein diagramed in order to have the polarity identical to N-pole magnetism that acts to the input terminal (21) of the input contact portion (2), resulting in the output contact portion (1) to be lowered down owing to repelling force in which case the contact strip (111) of the output terminal (11) is disconnected with the fixed terminal (15) which disallows flow of current for safety. Despite this, the output terminal (11′) of the output contact portion (1′) positioned in the opposite part still remains as lifted.

Next, if the protective cover (200) is detached from the charger (100) for use of the mobile phone (300), as shown in FIG. 6c, the output contact portion (1′) is lowered due to its self-weight, which concurrently makes the contact strip (111′) of the output terminal (11′) to be separated with the fixed terminal (15′) and in turn to be contacted with the second fixed terminal (17). The contacting of the aforesaid contact strip (111′) and the aforesaid second fixed terminal (17) generates and sends signals to the means of detection and control not diagramed herein, which in turn allows the direction of current having been flowing to the electromagnet (16) to change and makes the magnetic polarity of its surface o be returned back to initial state by converting N pole to S pole.

As such, if the polarity of the aforesaid electromagnet (16) is converted to its initial S pole, the input contact portions (2, 2′) of the protective cover (200) and the output contact portions (1, 1′) become ready of contacting anytime for charging as their polarities differ with each other, while in a state of flow of current blocked, which provides highest safety.

And the output contact portion (1, 1′) that moves upward and downward, if the metallic strip (18) is structured to be embedded to the lower part of the supports (14, 14′) as shown in FIG. 7, gets attached to the strip owing to attractive force of magnetism through which its stable positioning, not being shaken, is achieved, providing another safety. In this regard, this invention configures the strength of attractive force acting between the aforesaid metallic strip (18) and the aforesaid output contact portion (1, 1′) to be lower than that acting between the output contact portion (1, 1′) and the input contact portion (2, 2′) so that the output contact portion (1, 1′) is lifted and contacted at the same time being spaced apart from the metallic strip (18) when both output contact portion (1, 1′) and input contact portion (2, 2′) approach with each other for charging.

In addition, by way of applying the input contact portions (2, 2′) to be directly mounted on the back cover (320) of the mobile phone (300) as shown in FIG. 8 or directly mounted to the battery (400) of the mobile phone (300) as shown in FIG. 8, the need for using the protective cover (200) is eliminated as direct charging is possible.

Though this invention by far provides descriptions and figurative illustrations as for its preferred embodiments, the scope of its construction and configuration is not limited to what is strictly described and illustrated as above. Therefore, it should be regarded that its revisions and changes including the equivalent to the appropriate extent be interpreted within the scope of this invention as those skilled in this art well understand that the revision and change of the abovementioned embodiments as appropriate are possible.

What is claimed is:

1. A battery charge apparatus for a mobile phone comprising;
a mobile phone having a connection jack for current and data link, a charger configured to induce positive electricity and negative electricity from a direct current power source to the output contact portions that are connected to a PCB, and a protective cover equipped with a PCB connected the input contact portions in such a manner that negative electricity and positive electricity are supplied by contacting the output contact portions of the charger while being connected to a charger connector for data link and charging,
wherein the output contact portions include anode and cathode output terminals which form a couple being exposed through two holes perforated on the top end of a housing thereof, fixation bolts engaged in such a manner that the output terminals are connected to PCB on the lower part thereof, and the permanent magnets being arranged between the output terminals and the PCB generating magnetic force,
wherein the input contact portions include anode and cathode output terminals which form a couple being exposed through two holes perforated on the bottom of a base thereof, fixation bolts engaged in such a manner that the input terminals are connected to the PCB on the lower part thereof, and the permanent magnets being arranged in between the input terminals and the PCB generating magnetic force,
wherein the permanent magnets are arranged in such a manner that the surface polarity of the magnet differs with each other in a way that the cathode output terminal and the anode output terminal in the output contact portions are polarized with S pole and N pole, respectively, and the permanent magnets are arranged in such a manner that the surface polarity of the magnet differs with each other in a way that the cathode output terminal and the anode output terminal in the input contact portions are polarized with S pole and N pole, respectively.

2. The battery charge apparatus for a mobile phone according to claim 1, wherein the output contact portions comprise the output terminals formed on one side thereof in such a manner that the contact strips are projected, the permanent magnets where the edge part of the output terminals thereof are injection molded into a resin layer and integrated in such a manner that the output terminals are positioned to the top end, the support frames having central rods which are inserted through the central hollow portions of the permanent magnets, fixation bolts fixing the support frames to the PCB, and the fixed terminals that are connected to the PCB (10) in such a manner that the contact strips of the output terminals are contacted or separated when the permanent magnets move upward or downward.

3. The battery charge apparatus for a mobile phone according to claim 2, wherein an electromagnet substitutes for the permanent magnets combining the output terminals thereof, and a second fixed terminal connecting to the PCB is additionally comprised in such a manner as to be contacted/separated to/from the contact strip of the output terminal.

4. The battery charge apparatus for a mobile phone according to claim 2, wherein a metallic strip is inserted into the lower part of the support frames.
